(19) United States
(12) Patent Application Publication
(10) Pub. No.: US 2020/0391220 A1
(43) Pub. Date: Dec. 17, 2020

(54) HERB GRINDING MACHINE

(71) Applicant: CANOPY GROWTH CORPORATION, SMITHS FALLS (CA)

(72) Inventors: TOM SHIPLEY, SMITHS FALLS (CA); JOHN PAUL HOWARD, NORTH AUGUSTA (CA)

(21) Appl. No.: 16/970,101

(22) PCT Filed: Feb. 25, 2019
(86) PCT No.: PCT/CA2019/050223

§ 371 Date: Aug. 14, 2020

Related U.S. Application Data
(60) Provisional application No. 62/635,168, filed on Feb. 26, 2018.

(51) Int. Cl. B02C 18/10; A47J 42/30; B02C 18/18

(52) U.S. Cl. CPC B02C 18/10; B02C 18/18; A47J 42/30

(57) ABSTRACT

A grinding machine for grinding herbs is provided, and can include a vertical-oriented vessel with a substantially horizontal separating screen disposed in the vessel, creating a grinding chamber above and a collecting chamber below. Rotating blades in the grinding chamber rotate above the screen where dried herbs placed in the grinding chamber are ground into smaller pieces by the rotating blade that can descend through openings disposed through the screen to accumulate in the collecting chamber. A lid enclosing the vessel can further include a feed chute for feeding dried herbs into the machine while it is operating.

### CROSS-REFERENCE TO RELATED APPLICATIONS

This application is based on and claims priority to U.S. Provisional Application Ser. No. 62/635,168 filed on Feb. 26, 2018 which is incorporated herein by reference in its entirety.

### BACKGROUND OF THE INVENTION

The present disclosure is related to the field of machines for grinding herbs, in particular, for grinding cannabis.

The grinding of herbs, in particular, dried cannabis, poses its own set of challenges, especially when grinding larger volumes of the herb in commercial quantities. Conventional grinding methods and machines that use blades or cutters can become gummed up with cannabis resins during the grinding or cutting process. Hand-operated grinders exist specifically for grinding cannabis for personal use but these grinders are not feasible, practical or scalable upwards in size for grinding larger quantities.

It is, therefore, desirable to provide an herb grinding machine that overcomes the shortcomings of existing devices used for grinding herbs.

### BRIEF SUMMARY OF THE INVENTION

A grinding machine for grinding herbs is provided. In some embodiments, the machine can comprise a vertical-oriented vessel with a substantially horizontal separating screen disposed in the vessel, creating a grinding chamber above and a collecting chamber below. At least one rotating blade can be disposed in the grinding chamber, rotating about an axis that is substantially perpendicular to the screen. The rotating blade can rotate above the screen by a predetermined distance. Dried herbs can be placed in the grinding chamber to be ground into smaller pieces by the rotating blade. The smaller pieces can then descend through a plurality of openings disposed through the screen to accumulate in the collecting chamber. In some embodiments, the vessel can be enclosed by a lid, further comprising a motor and a gearbox operatively coupling the motor to the rotating blade. The lid can further comprise a feed chute to feed dried herbs into the machine while it is operating.

For the purposes of this description, and the claims herein, the term “diameter” shall mean the minimum distance across an opening, regardless if the opening is circular in configuration or not.

Broadly stated, in some embodiments, a grinding machine can be provided for grinding herbs, the grinding machine comprising: a vessel further comprising a mouth providing communication to an interior chamber therein; a substantially planar screen disposed in the interior chamber in a substantially horizontal configuration, the screen separating the interior chamber into a grinding chamber disposed above the screen and a collecting chamber disposed below the screen, the screen comprising a plurality of openings disposed therethrough; at least one rotor disposed in the grinding chamber, the at least one rotor configured to rotate about an axis substantially perpendicular to the screen; and a motor configured to rotate the at least one rotor.

Broadly stated, in some embodiments, the screen can further comprise a screen frame and a mesh further comprising the plurality of openings.

Broadly stated, in some embodiments, one or more of the plurality of openings can further comprise a diameter ranging from 0.1 to 0.5 inches.

Broadly stated, in some embodiments, the grinding machine can further comprise a lid configured to cover the mouth and prevent communication to the interior chamber.

Broadly stated, in some embodiments, the lid can further comprise one or more sight glasses configured for visually inspecting the interior chamber when the lid is covering the mouth.

Broadly stated, in some embodiments, the lid can further comprise a feed chute configured to provide communication into the interior chamber for feeding the herbs into the grinding chamber.

Broadly stated, in some embodiments, the grinding machine can further comprise a gear box disposed on the lid, the gear box operatively coupling the motor to the at least one rotor, the motor and the gear box configured to rotate the at least one rotor at a speed of 40 to 60 revolutions per minute.

Broadly stated, in some embodiments, the at least one rotor can further comprise a rotor flight operatively coupled thereto, the rotor flight extending towards the screen.

Broadly stated, in some embodiments, the grinding machine can further comprise a scraper blade operatively coupled to the rotor flight, the scraper blade extending towards the screen.

Broadly stated, in some embodiments, the at least one rotor can be configured to rotate above the screen by a predetermined distance.

Broadly stated, in some embodiments, the predetermined distance can be in the range of 0.01 to 0.1 inches.

Broadly stated, in some embodiments, a method for grinding herbs can be provided, the method comprising the steps of: providing a grinding machine, comprising: a vessel further comprising a mouth providing communication to an interior chamber therein, a substantially planar screen disposed in the interior chamber in a substantially horizontal configuration, the screen separating the interior chamber into a grinding chamber disposed above the screen and a collecting chamber disposed below the screen, the screen comprising a plurality of openings disposed therethrough, at least one rotor disposed in the grinding chamber, the at least one rotor configured to rotate about an axis substantially perpendicular to the screen, and a motor configured to rotate the at least one rotor; placing an amount of herb to be ground into the grinding chamber; and rotating the at least one rotor to grind the herb to produce ground herb, wherein at least some of the ground herb passes through the screen into the collecting chamber.

Broadly stated, in some embodiments, the method can further comprise the step of covering the mouth with a lid configured to prevent communication to the interior chamber.

Broadly stated, in some embodiments, the method can further comprise the step of feeding the herbs through a feed chute into the grinding chamber.

Broadly stated, in some embodiments, the method can further comprise the step of rotating the at least one rotor above the screen by a predetermined distance.

### BRIEF DESCRIPTION OF THE DRAWINGS

FIG. 1 is a perspective view depicting one embodiment of an herb grinding machine.

FIG. 2 is a top plan view depicting the herb grinding machine of FIG. 1.

FIG. 3 is a front elevation view depicting the herb grinding machine of FIG. 1.

FIG. 4 is a side elevation view depicting the herb grinding machine of FIG. 1.

FIG. 5 is a perspective view depicting a vessel of the grinding machine of FIG. 1.

FIG. 6 is a top plan view depicting the vessel of FIG. 5.

FIG. 7 is a front elevation view depicting the vessel of FIG. 5.

FIG. 8 is a side elevation view depicting the vessel of FIG. 5.

FIG. 9 is a perspective view depicting a screen of the vessel of FIG. 5.

FIG. 10 is a top plan view depicting the screen of FIG. 9.

FIG. 11 is a side elevation view depicting the screen of FIG. 9.

FIG. 12 is a perspective view depicting a lid assembly of the herb grinding machine of FIG. 1.

FIG. 13 is a side elevation view depicting a rotor shaft of the lid assembly of FIG. 12.

FIG. 14 is a top plan view depicting the lid assembly of FIG. 12.

FIG. 15 is a front elevation view depicting the lid assembly of FIG. 12.

FIG. 16 is a side elevation view depicting the lid assembly of FIG. 12.

FIG. 17 is a perspective view depicting a lid of the lid assembly of FIG. 12.

FIG. 18 is a perspective view depicting a gearbox frame of the lid assembly of FIG. 12.

FIG. 19 is a perspective view depicting a rotor of the lid assembly of FIG. 15.

FIG. 20 is a perspective view depicting a base assembly of the herb grinding machine of FIG. 1.

FIG. 21 is a perspective view depicting a feed chute of the herb grinding machine of FIG. 1.

FIG. 22 is a perspective view depicting a feed chute door of the feed chute of FIG. 21.

### DETAILED DESCRIPTION OF PREFERRED EMBODIMENT

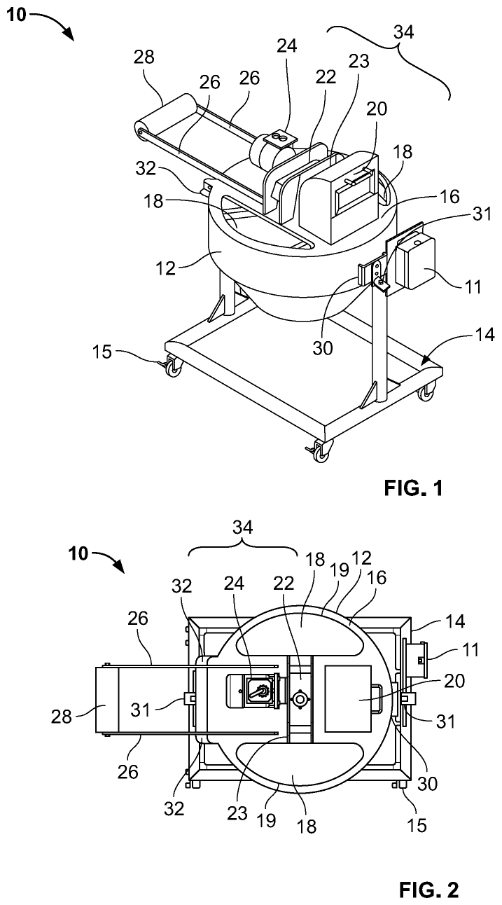

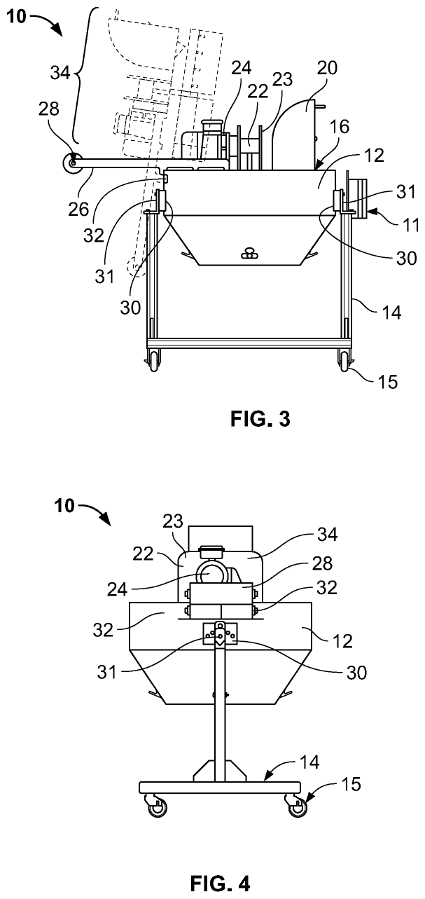

Referring to FIGS. 1 to 4, one embodiment of grinding machine 10 is shown. In some embodiments, grinding machine 10 can comprise vertically-oriented vessel 12 supported by base 14, further supported by casters 15, that can enable grinding machine 10 to be rolled around. Vessel 12 can operatively attach to base 14 via coupling brackets 30. In some embodiments, grinding machine 10 can comprise lid assembly 34 hingeably attached to vessel 12 via hinge 32. Lid assembly 34 can comprise of lid 16, which can further comprise of at least one sight glass 18 to enable visual inspection inside when grinding machine 10 is in operation. Lid assembly 34 can further comprise gear box frame 23 disposed thereon for attaching gearbox 22 thereto. Lid assembly 34 can further comprise motor 24 operatively coupled to gearbox 22. Gear box frame 23 is shown in more detail in FIG. 18. In some embodiments, motor 24 can comprise a single-phase or 3-phase AC electric motor although a hydraulic motor or any other suitable motor technology can be used, as well known to those skilled in the art. When an electric motor is used, grinding machine 10 can comprise electrical panel 11 that can comprise electrical wiring and switchgear for operating motor 24. In some embodiments, lid assembly 34 can comprise outrigger arms 26 configured for supporting counterweight 28 attached thereto. The use of outrigger arms 26 and counterweight 28 can counter the weight of motor 24 and gearbox 22, which can enable easy lifting of lid assembly 34 about hinge 32 from a closed position to an open position, as shown in FIG. 3.

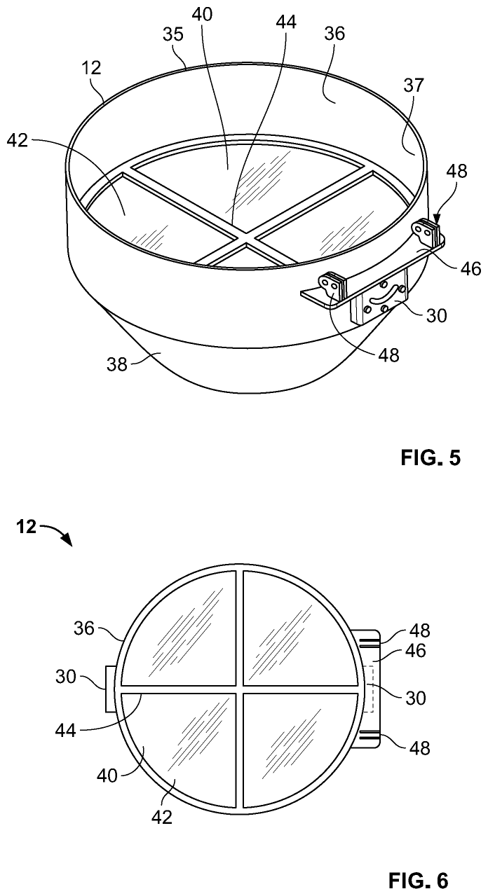

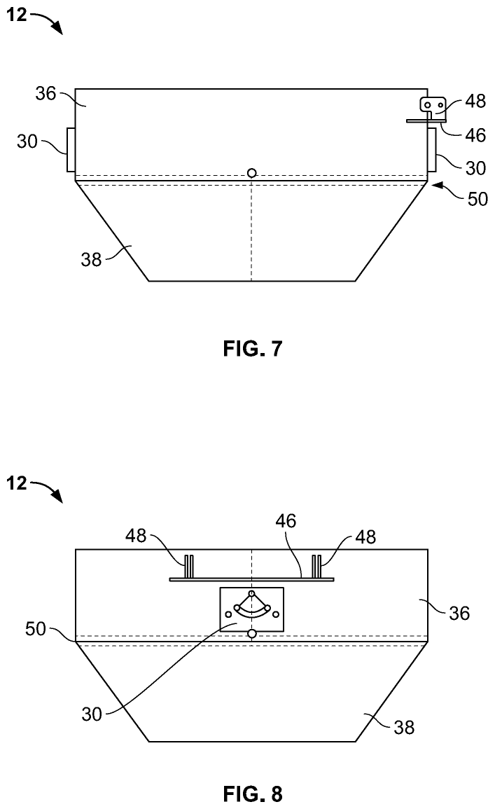

Referring to FIGS. 5 to 8, one embodiment of vessel 12 is shown. Vessel 12 defines a mouth 35, or opening, providing access to an interior chamber 37 defined by walls of vessel 12. In some embodiments, vessel 12 can comprise an upper portion, shown as grinding chamber 36, and a lower portion, shown as collecting chamber 38. Base ring 50 can be disposed within vessel 12 at the junction between chambers 36 and 38 to serve as a support for screen 40, which can sit on base ring 50 during grinding operations and can further be removed to retrieve ground herbs from collecting chamber 38. Screen 40 can, in some embodiments, comprise screen frame 44 and perforated portion 42. Screen 40 separates interior chamber 37 into grinding chamber 36, positioned above screen 40, and collecting chamber 38, positioned below screen 40. In some embodiments, vessel 12 can comprise hinge plate 48 further comprising hinges 46 disposed thereon for hingeably connecting to lid assembly 34, as shown in FIGS. 1 to 4.

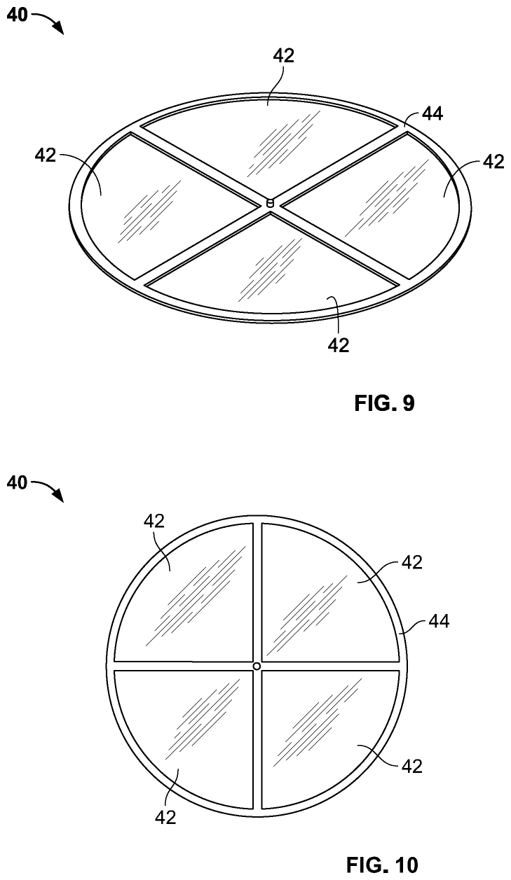

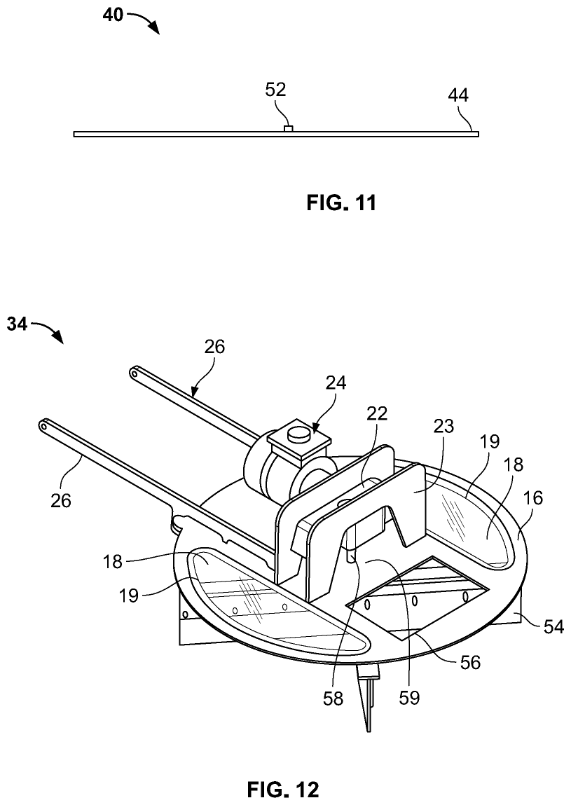

Referring to FIGS. 9 to 11, one embodiment of screen 40 is shown. In some embodiments, perforated portion 42 can be formed by drilling a plurality of holes through a solid disk used for screen 40. In this embodiment, screen frame 44 can represent the portions of said solid disk where holes are not drilled through. In some embodiments, the holes can comprise a plurality of 3/16″ holes places ¼″ apart in a staggered configuration although the size of the holes, and the spacing in-between, can each be adjusted upwards or downwards as necessary by those skilled in the art. In some embodiments, screen 40 can comprise threaded stud 52 disposed at the centre thereof.

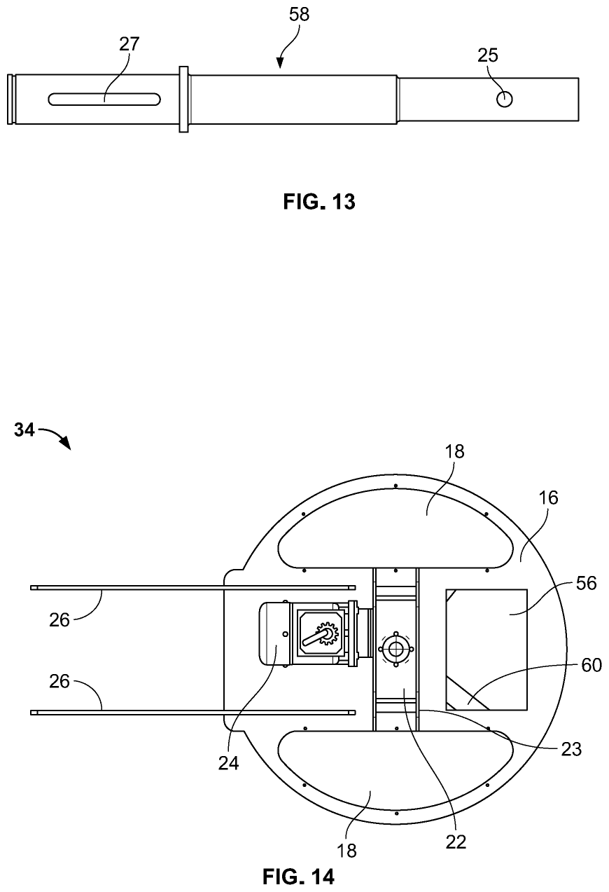

Referring to FIG. 12, one embodiment of lid assembly 34 is shown. Gear box frame 23 can be disposed on top of lid 16 to support gear box 22, which can be operatively coupled to motor 24. Gear box 22 can reduce the rotational speed of a motor shaft (not shown) extending from motor 24 to rotate rotor shaft 58 that can extend through opening 59 in lid 16 to rotate rotor assembly 54. In some embodiments, gear box 22 can comprise a worm gear assembly, as well known to those skilled in the art, to enable the aforementioned motor shaft to rotate rotor shaft 58 that can be substantially perpendicular to the motor shaft. Openings 19 disposed through lid 16 can support sight glasses 18, which can enable visual inspection inside vessel 12 when grinding machine 10 is in operation. Referring to FIG. 13, one embodiment of rotor shaft 58 is shown. In some embodiments, rotor shaft 58 can comprise slot 27 configured for operatively coupling to gear box 22. Rotor shaft 58 can further comprise opening 25 configured for operatively coupling to rotor assembly 54, as shown in FIG. 12.

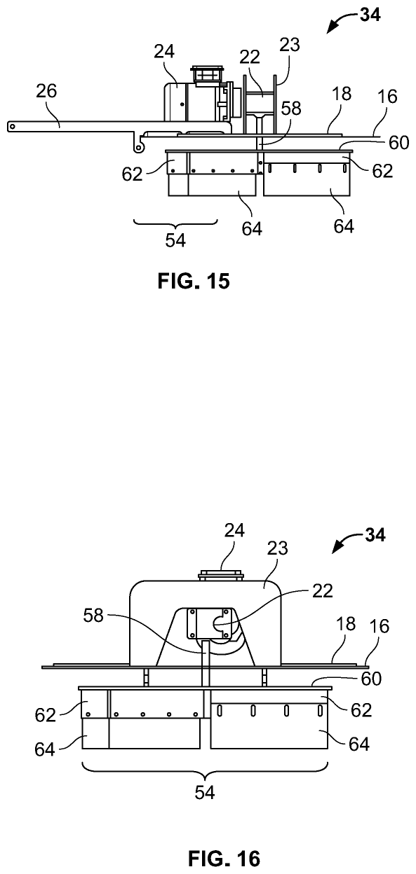

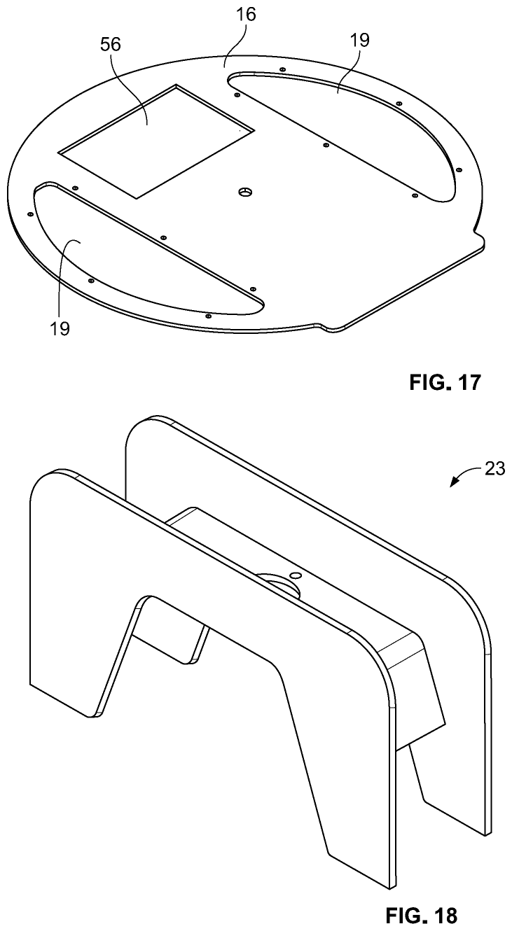

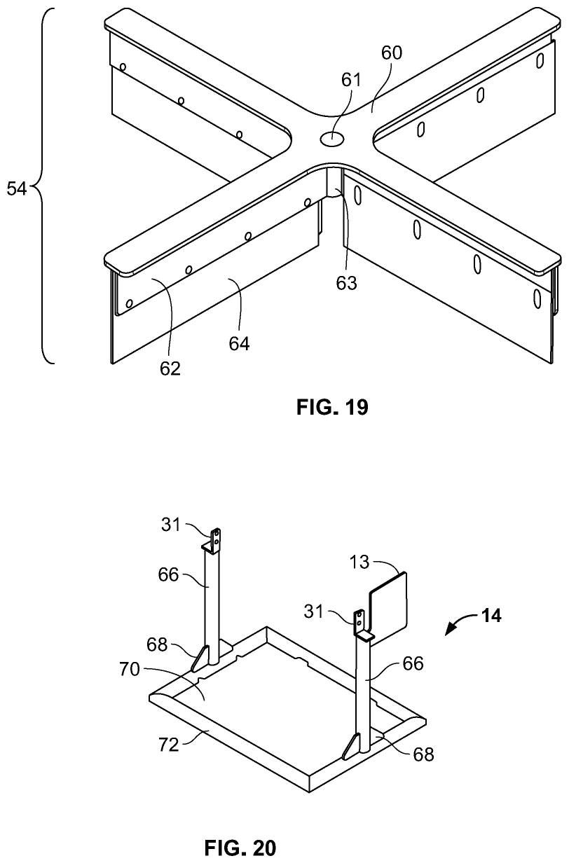

Referring to FIGS. 14 to 16, one embodiment of lid assembly 34 is shown. In some embodiments, lid 16 can comprise opening 56 disposed therethrough to enable feedstock to be introduced into vessel 12 when grinding machine 10 is operating. This is shown in more detail in FIG. 17. In some embodiments, rotor assembly 54 can be operatively coupled to rotor shaft 58. In some embodiments, rotor assembly 54 can comprise of an cross-shaped rotor top 60 to provide four “arms” to which blades can be attached to, although rotor top 60 can be configured to increase or decrease the number of rotating blades as deemed necessary by those skilled in the art. In some embodiments, each “arm” of rotor top 60 can comprise a rotor flight 62 attached thereto, wherein a rotor blade 64 can attach to each rotor flight 62. By making rotor blade 64 a separate element from rotor flight 62, rotor blades 64 can be replaced as needed when they wear out or become damaged during grinding operations. FIG. 19 provides a view of rotor assembly 54 separate from lid assembly 34. Rotor top 60 comprises opening 61 for receiving rotor shaft 58, wherein opening 63 can align with opening 25 in rotor shaft 58 for a bolt or fastener (not shown) to couple rotor top 60 to rotor shaft 58.

Referring to FIG. 20, one embodiment of base 14 is shown. In some embodiments, base 14 can comprise of base frame 72 having a pair of legs 66 extending substantially perpendicularly therefrom, the upper ends of legs 66 comprising brackets 31 configured for attachment to brackets 30 on vessel 12. Legs 66 can further comprise gussets 68 to provide further attachment support with base frame 72. Base frame 72 can further comprise bottom panel 70 therein. In embodiments where motor 24 is an electrical motor, one leg 66 can comprise panel plate 13 to support electrical panel 11 thereon.

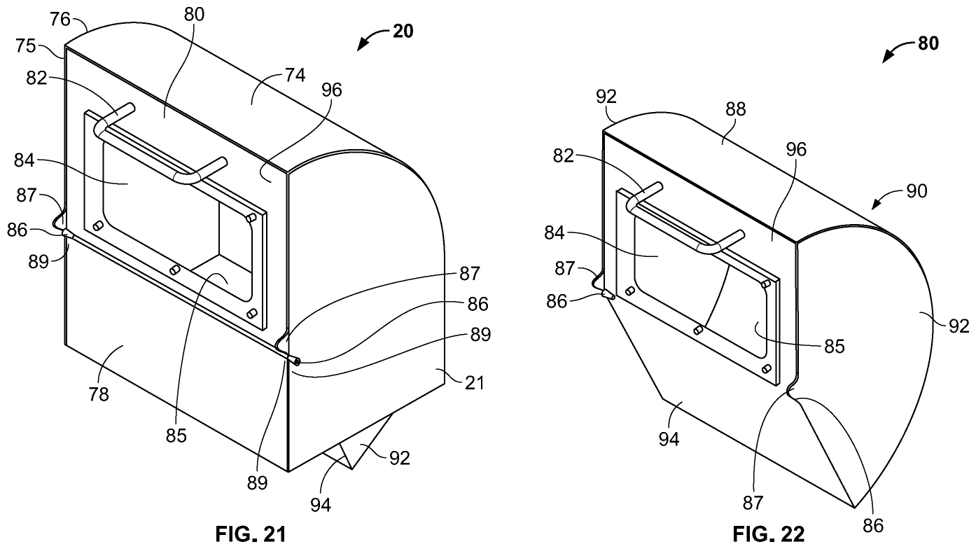

Referring to FIGS. 21 and 22, one embodiment of feed chute 20 is shown. In some embodiments, feed chute 20 can comprise housing 21 further comprised of back portion 74, side portions 76 and front portion 78, all configured to form opening 75 for receiving chute door 80. In some embodiments, chute door 80 can comprise top portion 88, side portions 92 and front portions 94 and 96, all configured to form door mouth 90 on a rear side thereof. Chute door 80 can further comprise hinge pins 86 configured to couple with pin openings 89 disposed on side portions 76 wherein chute door 80 can pivot forward in housing 21 about hinge pins 86 to reveal door mouth 90 to insert herb feed stock to be fed into vessel 12 when grinding machine 10 is in operation. Chute door 80 can comprise handle 82 for pulling and opening chute door 80 in housing 21, and can further comprise opening 85 therethrough, which can be covered by sight glass 84 so as to enable visual inspection of feed stock being fed into vessel 12.

In operation, motor 24 rotates rotor assembly 54 within grinding chamber 36 such that rotor blades 64 rotate above screen 40 by a predetermined distance. In some embodiments, the predetermined distance can range from 1 to 2 mm. In some embodiments, motor 24 and gear box 22 can be configured to rotate rotor blades at a rotational speed of about 50 revolutions per minute (“RPM”), although this rotational speed can be adjusted upwards or downwards by 10 RPM or more as required to maximize the grinding efficiency of grinding machine 10. While grinding machine 10 is in operation, herb feed stock can be inserted into vessel 12 by opening chute door 80 and feeding dried herb feed stock therein. Once inserted, the herb feed stock falls onto screen 40 where rotor blades 64 can contact the herb feed stock thereby breaking the feed stock into smaller pieces. As rotor blades 64 continue to rotate and contact the herb feed stock, the herbs will break into smaller and smaller pieces until they can pass through the openings on perforated portion 42 in screen 40 to collect in collecting chamber 38. Once ground herbs have been collected in collecting chamber 38, motor 24 can be turned off to stop rotation of rotor assembly 54 so that lid assembly 34 can be tilted open to provide access into vessel 12. Screen 40 can then be lifted out of vessel 12 to provide access to collecting chamber 38 so that the ground herbs can be removed therefrom.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

1. A grinding machine for grinding herbs, the grinding machine comprising:
a) a vessel defining a mouth providing communication to an interior chamber therein;
b) a substantially planar screen disposed in the interior chamber in a substantially horizontal configuration, the screen separating the interior chamber into a grinding chamber disposed above the screen and a collecting chamber disposed below the screen, the screen defining a plurality of openings disposed therethrough;
c) at least one rotor disposed in the grinding chamber, the at least one rotor configured to rotate about an axis substantially perpendicular to the screen; and
d) a motor configured to rotate the at least one rotor.

2. The grinding machine as set forth in claim 1, wherein the screen comprises a screen frame and a mesh that defines the plurality of openings.

3. The grinding machine as set forth in claim 1, wherein one or more of the plurality of openings comprises a diameter ranging from 0.1 to 0.5 inches.

4. The grinding machine as set forth in claim 1, further comprising a lid configured to cover the mouth and prevent communication to the interior chamber.

5. The grinding machine as set forth in claim 4, wherein the lid further comprises one or more sight glasses configured for visually inspecting the interior chamber when the lid is covering the mouth.

6. The grinding machine as set forth in claim 4, wherein the lid further comprises a feed chute configured to provide communication into the interior chamber for feeding herbs into the grinding chamber.

7. The grinding machine as set forth in claim 4, further comprising a gear box disposed on the lid, the gear box operatively coupling the motor to the at least one rotor, the motor and the gear box configured to rotate the at least one rotor at a speed of 40 to 60 revolutions per minute.

8. The grinding machine as set forth in claim 1, wherein the at least one rotor comprises a rotor flight operatively coupled thereto, the rotor flight extending towards the screen.

9. The grinding machine as set forth in claim 8, further comprising a scraper blade operatively coupled to the rotor flight, the scraper blade extending towards the screen.

10. The grinding machine as set forth in claim 1, wherein the at least one rotor is configured to rotate above the screen by a predetermined distance.

11. The grinding machine as set forth in claim 10, wherein the predetermined distance is in the range of 0.01 to 0.1 inches.

12. A method for grinding herbs, the method comprising the steps of:
a) providing a grinding machine, comprising:
i) a vessel defining a mouth providing communication to an interior chamber therein,
ii) a substantially planar screen disposed in the interior chamber in a substantially horizontal configuration, the screen separating the interior chamber into a grinding chamber disposed above the screen and a collecting chamber disposed below the screen, the screen defining a plurality of openings disposed therethrough,
iii) at least one rotor disposed in the grinding chamber, the at least one rotor configured to rotate about an axis substantially perpendicular to the screen, and
iv) a motor configured to rotate the at least one rotor;
b) placing an amount of herb to be ground into the grinding chamber; and
c) rotating the at least one rotor to grind the herb to produce ground herb, wherein at least some of the ground herb passes through the openings in the screen into the collecting chamber.

13. The method as set forth in claim 12, wherein the screen comprises a screen frame and a mesh that defines the plurality of openings.

14. The method as set forth in claim 12, wherein one or more of the plurality of openings comprises a diameter ranging from 0.1 to 0.5 inches.

15. The method as set forth in claim 12, further comprising the step of covering the mouth with a lid configured to prevent communication to the interior chamber.

16. The method as set forth in claim 15, wherein the lid further comprises one or more sight glasses configured for visually inspecting the interior chamber when the lid is covering the mouth.

17. The method as set forth in claim 15, further comprising the step of feeding the herbs through a feed chute into the grinding chamber.

18. The method as set forth in claim 15, wherein the grinding machine further comprises a gear box disposed on the lid, the gear box operatively coupling the motor to the at least one rotor, the motor and the gear box configured to rotate the at least one rotor at a speed of 40 to 60 revolutions per minute.

19. The method as set forth in claim 12, wherein the at least one rotor comprises a rotor flight operatively coupled thereto, the rotor flight extending towards the screen.

20. The method as set forth in claim 19, wherein the at least one rotor comprises a scraper blade operatively coupled to the rotor flight, the scraper blade extending towards the screen.

21. The method as set forth in claim 12, further comprising the step of rotating the at least one rotor above the screen by a predetermined distance.

22. The method as set forth in claim 21, wherein the predetermined distance is in the range of 0.01 to 0.1 inches.
